(19) United States
(12) Patent Application Publication
(10) Pub. No.: US 2008/0198087 A1
(43) Pub. Date: Aug. 21, 2008

(54) DUAL-BAND ANTENNA

(75) Inventors: Yu-Chiang Cheng, Taipei City (TW); Ping-Cheng Chang, Chaojhou Township (TW); Cheng-Zeng Chou, Sinying City (TW)

Correspondence Address: APEX JURIS, PLLC, 12360 LAKE CITY WAY NORTHEAST, SUITE 410, SEATTLE, WA, 98125, US

(73) Assignee: Mitac Technology Corp., Hsin-Chu Hsien (TW)

(21) Appl. No.: 11/676,181

(22) Filed: Feb. 16, 2007

(51) Int. Cl. H01Q 1/48

(52) U.S. Cl. 343/845

(57) ABSTRACT

A dual-band antenna is provided, which includes a signal resonance unit, a grounding unit, a connection unit, and a signal line. The grounding unit is disposed opposite to the signal resonance unit. The connection unit has a first connection element and a second connection element, wherein one end of the first connection element is connected to the signal resonance unit and the other end of the first connection element is connected to the grounding unit, while one end of the second connection element is connected to one side of the first connection element. The signal line has a signal feeding end and a circuit connection end, wherein the signal feeding end is electrically connected to the second connection element, and the circuit connection end is electrically connected to a wireless circuit device.

### BACKGROUND OF THE INVENTION

1. Field of Invention

The present invention relates to a signal transceiver, and more particularly to a dual-band signal transceiver for radio signal transmission.

2. Related Art

In recent years, as people's demand on wireless communication is growing higher, the elements used in wireless communication have become the main trend for research and development work. In the field of wireless communication, antenna is an important element for receiving and transmitting signals. An antenna is a electrical coupling element or conducting system that can convert an electrical signal in the circuit to the electromagnetic energy in the space. When transmitting a signal, the antenna converts the electric energy of radio frequency into electromagnetic energy which is then radiated to the surrounding environment. When receiving a signal, the antenna receives the electromagnetic energy radiation and converts it into the electric energy of radio frequency which is then provided to a receiver for being processed. Generally, the performance of an antenna is described by a radiation pattern wherein the antenna radiates energy in all directions, which is a way of describing the antenna radiation property into a space function. Due to the coming of the mobile communication age, products with a light weight, small volume, good signal reception and low cost have become the mainstream of the market, and whether the antenna design is excellent or not plays an important role. Being a miniaturized antenna, a dual-band antenna generates two resonance frequencies under a fixed antenna size, and thus has a performance just like the combination of two single-frequency antenna.

As the dual-band antenna also develops toward having a smaller volume, in design, the signal resonance element is gradually transformed from a sheet form into a linear form. Therefore, in the prior art, an improved inverted-F antenna is shown in FIG. 1, the dual-band antenna 10 is provided with a signal resonance unit 11, a grounding unit 12, a signal line 14 having a signal feeding end 13 connected to the signal resonance unit 11 and a circuit connection end 15 connected to a wireless circuit device, and a connection unit 17 having one end connected to the signal resonance unit 11 and the other end connected to the grounding unit 12. When a signal is fed from the signal feeding end 13 into the signal resonance unit 11, the signal is transmitted out in two, left and right, paths and connected to the grounding unit 12 via the connection unit 17. However, as the two paths are of different lengths, electromagnetic waves of two different frequencies are sent out. In addition, the signal transmitted out in the path whose length is a quarter of the wavelength of the electromagnetic wave is claimed to have the dual-band effect. Likewise, it is the same when an electromagnetic wave signal is received. However, during practical signal path transmission, as for the circuit on the right side of the signal feeding end 13, when the right side of the signal resonance unit 11 is to receive a signal, the signal first passes through one end of the connection unit 17, i.e., an end of the ground path, such that the signal may be directly transmitted to the grounding unit 12 instead of being fed to the signal feeding end 13. Therefore, the above design cannot produce the dual-band receiving/transmitting effect in practice, and can only be regarded as a single-frequency antenna.

Further, in a dual-band antenna disclosed by U.S. Pat. No. 6,861,986B2, the ground path is designed to be combined with the signal path, i.e., the feeding line is connected to the interconnecting element, so as to eliminate the above-mentioned problems in the prior art. However, as the interconnecting element is composed by three parts, the fabrication of the interconnecting element at least needs two solder joints, which increases the fabrication process, and is time and energy consuming. Moreover, the increase of the solder joints also worsens the uncertainty of the product yield and makes it easy to couple a portion of the noises. Additionally, in the above design, a ground path has two right-angled turns, which affects the transmission through the ground path, and makes it difficult to adjust the input/output impedance. Such problem concerns the distance from the signal feeding end to the grounding unit, and can cause poor impedance matching.

Therefore, under the requirement of a short, small, light, and thin dual-band antenna, the structure of the dual-band antenna is very likely to be limited. For example, in the above design, the dual-band transmission effect cannot be achieved effectively. The complexity of the fabrication process and the problem of signal transmission caused by the difficulty in obtaining preferred impedance matching by adjusting must be solved, so as to optimize the performance of the dual-band antenna.

### SUMMARY OF THE INVENTION

In view of the above, the present invention is directed to providing a dual-band antenna which has a simpler fabrication process, fewer solder joints, and a variable structure, so as to solve the problem of being time and energy consuming caused by the complicated process and the problem of poor impedance matching caused by the difficulty in adjusting the input/output impedance in the prior art.

In order to achieve the above objective, the present invention provides a dual-band antenna, which comprises a signal resonance unit, a grounding unit disposed opposite to the signal resonance unit, a connection unit, and a signal line. The connection unit is has a first connection element and a second connection element, wherein one end of the first connection element is connected to the signal resonance unit and the other end is connected to the grounding unit, while one end of the second connection element is connected to one side of the first connection element. The signal line has a signal feeding end and a circuit connection end, wherein the signal feeding end is electrically connected to the second connection element, and the circuit connection end is electrically connected to a wireless circuit device.

The advantage of the present invention is using the currently available design principle of an inverted-F antenna to alter the structure of the ground path, so as to re-allocate the current feeding path. Accordingly, the limitation on the structure of the ground path in the conventional inverted-F antenna can be eliminated. Meanwhile, an optimal impedance matching can be obtained by connection units of various structures together with appropriate feeding manners, so as to achieve the maximum performance of the antenna radiation.

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings.

The above description of the content of the present invention and the following illustration of the embodiments are intended to demonstrate and explain the principle of the present invention and to provide further explanations of the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a side view of the dual-band antenna in the prior art;

FIG. 2 is a side view of the first embodiment of the present invention;

FIG. 3 is a side view of the second embodiment of the present invention;

FIG. 4 is a side view of the third embodiment of the present invention;

FIG. 5 is a side view of the fourth embodiment of the present invention; and

FIG. 6 is a side view of the fifth embodiment of the present invention.

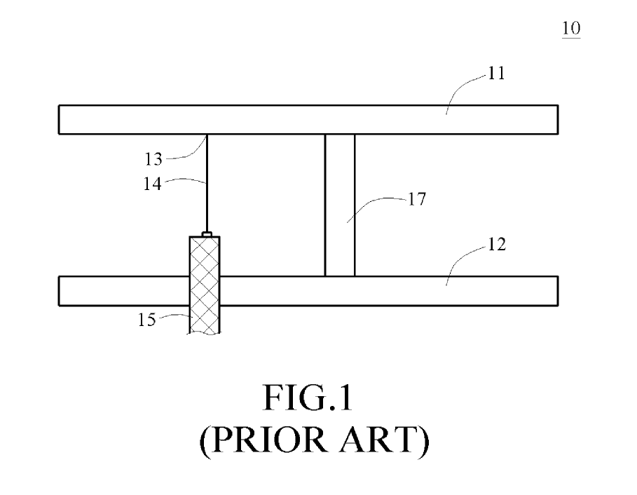

### DETAILED DESCRIPTION OF THE INVENTION

The objectives, structures, features, and functions of the present invention will be illustrated in detail below accompanied with the embodiments.

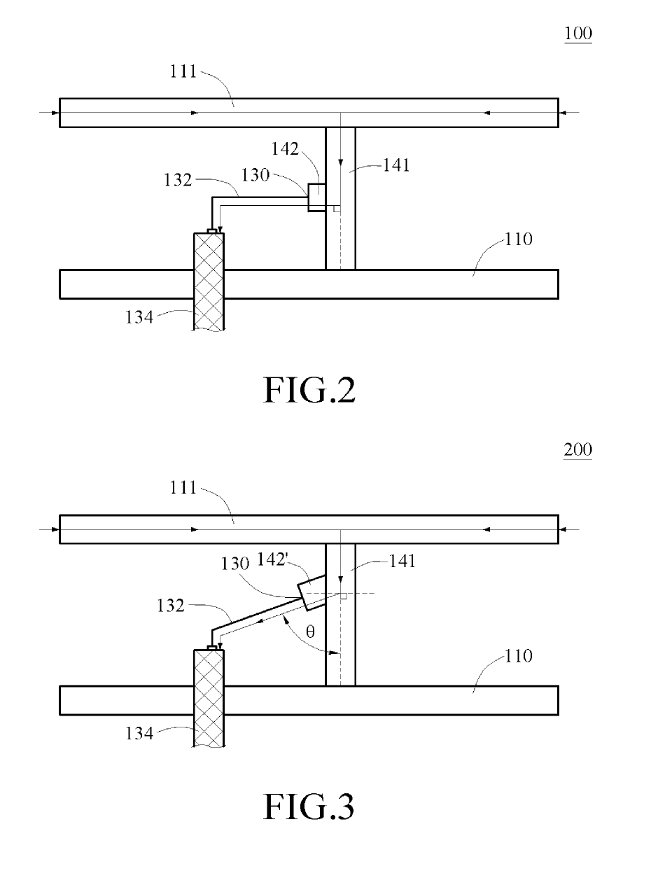

First, referring to FIG. 2, a side view of the first embodiment of the present invention is shown. In FIG. 2, the dual-band antenna 100 according to the first embodiment of the present invention has a signal resonance unit 111, a grounding unit 110 disposed opposite to the signal resonance unit 111, a connection unit, and a signal line 132.

The connection unit has a first connection element 141 and a second connection element 142. A signal feeding end 130 of the signal line 132 is connected to the second connection element 142 of the connection unit, and a circuit connection end 134 of the signal line 132 is connected to a wireless circuit device, so as to form a signal path.

One end of the first connection element 141 of the connection unit is perpendicularly connected to the signal resonance unit 111, and the other end is perpendicular to the grounding unit 110. The second connection element 142 is perpendicularly disposed on one side of the first connection element 141, wherein one end of the second connection element 142 is connected to one side of the first connection element 141, and the other end is connected to the signal feeding end 130 of the signal line 132. Therefore, as shown by the arrowed path direction in FIG. 2, a signal is received at both ends of the signal resonance unit 111, transmitted through a right-angled turn in the first connection element 141 to the second connection element 142, then fed into the signal line 132 from the signal feeding end 130, and finally connected to the wireless circuit device via the circuit connection end 134, thus forming a signal path having two receive frequencies. A signal sent from the wireless circuit device is transmitted out along the above path in a reversed direction, and finally a radio signal is sent out from the two ends of the signal resonance unit 111. The signal resonance unit 111 is connected to the grounding unit 110 through the first connection element 141, i.e., a signal is transmitted into the first connection element 141, and then directly connected to the grounding unit 110 without any right-angled turn, as shown by the dashed line in FIG. 2, thus forming a ground path. The ground path of the present invention has low transmission impedance, which is advantageous in reducing the noise signal.

Referring to FIG. 3, a side view of the second embodiment of the present invention is shown. The main structure of the dual-band antenna 200 according to the second embodiment of the present invention is similar to that of the dual-band antenna 100 of the first embodiment. The main difference is that the second connection unit 142′ in the dual-band antenna 200 is obliquely disposed at one side of the first connection element 141, and extends toward the grounding unit 110, and the other end of the second connection unit 142′ is connected to the signal feeding end 130. Therefore, as shown by the arrowed path direction in FIG. 3, a signal is received at both ends of the signal resonance unit 111, transmitted through a turn of an acute angle θ (smaller than the degree of a right angle) in the first connection element 141 to the second connection element 142′, then fed into the signal line 132 from the signal feeding end 130, and finally connected to the wireless circuit device via the circuit connection end 134, thus forming a signal path having two receive frequencies. In this embodiment, as the signal path has no right-angled turn, the signal is more easily sent to the signal feeding end 130 for further transmission. Likewise, a transmit signal goes along the signal path in a reversed direction.

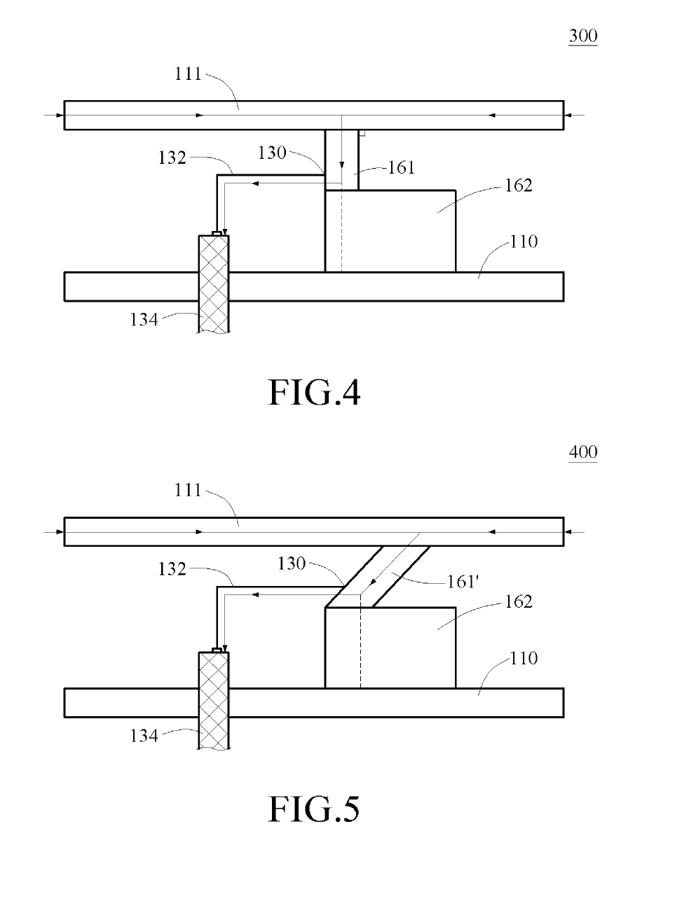

Next, referring to FIG. 4, a side view of the third embodiment of the present invention is shown. The dual-band antenna 300 according to the third embodiment of the present invention also has a signal resonance unit 111, a grounding unit 110 disposed opposite to the signal resonance unit 111, a connection unit, and a signal line 132. The connection unit is constituted by a first connection element 161 and a second connection element 162.

However, in this embodiment, a signal feeding end 130 of the signal line 132 is connected to a side surface of the first connection element 161 of the connection unit, and a circuit connection end 134 of the signal line 132 is connected to the wireless circuit device, so as to form a signal path.

The second connection element 162 of the connection unit is a block. One end of the first connection element 161 is perpendicularly connected to the signal resonance unit 111, and the other end is perpendicularly disposed on the top surface of the second connection element 162 connected to the first connection element 161. Another surface of the second connection element 162, opposite to the top surface connected to the first connection element 161, is connected to the grounding unit 110. Therefore, as shown by the arrowed path direction in FIG. 4, a signal is received at both ends of the signal resonance unit 111, directly transmitted to the signal feeding end 130 through the first connection element 161 connected thereto for being fed into the signal line 132, and then connected to the wireless circuit device via the circuit connection end 134, thus forming a signal path having two receive frequencies. A signal sent from the wireless circuit device is transmitted out along the above path in a reversed direction, and finally a radio signal is sent out from the two ends of the signal resonance unit 111. The signal resonance unit 111 is connected to the grounding unit 110 through the first connection element 161 and the second connection element 162, thus forming a ground path, as shown by the dashed line in FIG. 4.

Next, referring to FIG. 5, a side view of the fourth embodiment of the present invention is shown. The main structure of the dual-band antenna 400 according to the fourth embodiment of the present invention is similar to that of the dual-band antenna 300 of the third embodiment. The main difference is that the first connection unit 161′ in the dual-band antenna 400 is obliquely connected to the signal resonance unit 111, and obliquely disposed at the top surface of the second connection element 162 connected to the first connection unit 161′. Therefore, in this embodiment, the signal is more easily sent to the signal feeding end 130 for further transmission.

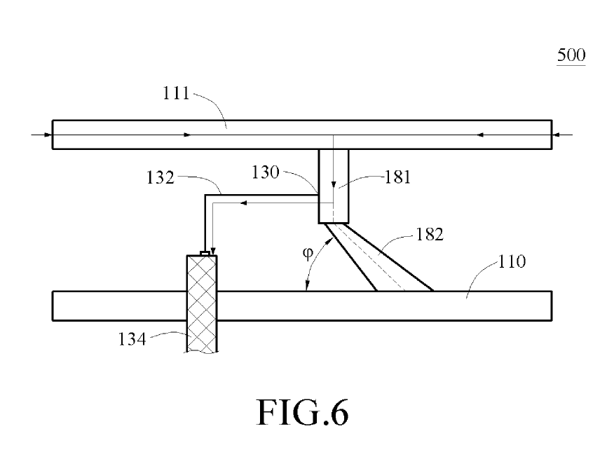

Then, referring to FIG. 6, a side view of the fifth embodiment of the present invention is shown. The dual-band antenna 500 according to the fifth embodiment of the present invention also has a signal resonance unit 111, a grounding unit 110 disposed opposite to the signal resonance unit 111, a connection unit, and a signal line 132. The connection unit is constituted by a first connection element 181 and a second connection element 182.

However, in this embodiment, a signal feeding end 130 of the signal line 132 is connected to a side surface of the first connection element 181 of the connection unit, and a circuit connection end 134 of the signal line 132 is connected to the wireless circuit device, so as to form a signal path.

One end of the first connection element 181 of the connection unit is perpendicularly connected to the signal resonance unit 111, and the other end of the first connection element 181 is connected to one end of the second connection unit 182. The other end of the second connection element 182 is obliquely connected to the grounding unit 110, and forms an acute angle φ with the grounding unit 110. Therefore, similarly, as shown by the arrowed path direction in FIG. 6, a signal is received at both ends of the signal resonance unit 111, directly transmitted to the signal feeding end 130 through the first connection element 181 connected thereto for being fed into the signal line 132, and then connected to the wireless circuit device via the circuit connection end 134, thus forming a signal path having two receive frequencies. A signal sent from the wireless circuit device is transmitted out along the above path in a reversed direction, and finally a radio signal is sent out from the signal resonance unit 111. The signal resonance unit 111 is connected to the grounding unit 110 through the first connection element 181 and the second connection element 182, so as to form a ground path, as shown by the dashed line in FIG. 6.

In the present invention, the connection unit of the dual-band antenna is constituted by a first connection element and a second connection element, such that only one solder joint is needed, thus solving the problem of a low production efficiency caused by complicated fabrication process and difficulty in welding. Moreover, in the present invention, the connection unit of the dual-band antenna may be provided with a low impedance, so as to form a preferred ground path, and make the signal noises smaller. Different embodiments of the present invention also provide more variations in the structure of the dual-band antenna, such that the dual-band antenna can have a varied signal feeding end to obtain an optimal impedance matching, thereby achieving the optimal quality of the signal.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dual-band antenna, comprising:
a signal resonance unit;
a grounding unit, disposed opposite to the signal resonance unit;
a connection unit, having a first connection element and a second connection element, wherein one end of the first connection element is connected to the signal resonance unit, the other end of the first connection element is connected to the grounding unit, and one end of the second connection element is connected to one side of the first connection element; and
a signal line, having a signal feeding end and a circuit connection end, wherein the signal feeding end is electrically connected to the second connection element, and the circuit connection end is electrically connected to a wireless circuit device.

2. The dual-band antenna as claimed in claim 1, wherein the second connection element is perpendicularly disposed at one side of the first connection element to form a signal path, such that a receive signal is transmitted to the first connection element from the signal resonance unit, then to the second connection element through a right-angled turn, and finally sent to the signal feeding end; a transmit signal goes along the signal path in a reversed direction.

3. The dual-band antenna as claimed in claim 1, wherein the second connection element is obliquely disposed at one side of the first connection element and extends toward the grounding unit to form a signal path, such that a receive signal is transmitted to the first connection element from the signal resonance unit, then to the second connection element through a turn smaller than a right angle, and finally sent to the signal feeding end; a transmit signal goes along the signal path in a reversed direction.

4. A dual-band antenna, comprising:
a signal resonance unit;
a grounding unit, disposed opposite to the signal resonance unit;
a connection unit, having a first connection element and a second connection element, wherein one end of the first connection element is connected to the signal resonance unit, the other end of the first connection element is connected to one end of the second connection element, and the other end of the second connection element is connected to the grounding unit; and
a signal line, having a signal feeding end and a circuit connection end, wherein the signal feeding end is electrically connected to the first connection element, and the circuit connection end is electrically connected to a wireless circuit device.

5. The dual-band antenna as claimed in claim 4, wherein the second connection element is a block.

6. The dual-band antenna as claimed in claim 4, wherein the two ends of the first connection element are perpendicularly connected to the signal resonance unit and the second connection element respectively to form a signal path, such that a receive signal is transmitted to the first connection element from the signal resonance unit and then directly sent to the signal feeding end; a transmit signal goes along the signal path in a reversed direction.

7. The dual-band antenna as claimed in claim 4, wherein the first connection element is obliquely connected to the signal resonance unit and the second connection element to form a signal path, such that a receive signal is transmitted to the first connection element from the signal resonance unit and then directly sent to the signal feeding end; a transmit signal goes along the signal path in a reversed direction.

8. The dual-band antenna as claimed in claim 4, wherein the first connection element is perpendicularly connected to the signal resonance unit, the signal feeding end of the signal line is connected to a side surface of the first connection element, and the second connection element is obliquely connected to the first connection element and the grounding unit.

9. The dual-band antenna as claimed in claim 8, wherein the signal resonance unit and the first connection element form a signal path, such that a receive signal is transmitted to the first connection element from the signal resonance unit and then directly sent to the signal feeding end; a transmit signal goes along the signal path in a reversed direction.
